(19) United States
(12) Patent Application Publication
(10) Pub. No.: US 2006/0216037 A1
(43) Pub. Date: Sep. 28, 2006

(54) Double-pass imaging pulse-stretcher

(76) Inventors: Alexander O. Wiessner, Goettingen (DE); Thomas Schroeder, Goettingen (DE); Hans-Stephan Albrecht, Goettingen (DE); R. Russel Austin, Cumbria (GB)

Correspondence Address: STALLMAN & POLLOCK LLP, 353 SACRAMENTO STREET, SUITE 2200, SAN FRANCISCO, CA, 94111, US

(21) Appl. No.: 11/087,479

(22) Filed: Mar. 23, 2005

(51) Int. Cl. H04B 10/00

(52) U.S. Cl. 398/161

(57) ABSTRACT

A pulse-stretcher has an optical delay loop including a beamsplitter. The beamsplitter divides an input pulse into a temporal sequence of pulse replicas, a first of which is transmitted by the beamsplitter and the remainder of which are reflected by the beamsplitter along the path of the transmitted replica. The sequence of replicas form an initially stretched pulse having a longer duration and lower peak power than the input pulse. A prism cooperative with the delay loop reflects the initially stretched pulse back into the delay loop along a path laterally displaced from the replica path. The beamsplitter divides the initially stretched pulse into a temporal sequence of pulse replicas propagating along a common path to form a finally stretched pulse, having a longer duration and a lower peak power than the initially stretched pulse. The finally stretched pulse has a sequence of power peaks. Peak power in the pulse is minimized when the beamsplitter reflectivity is selected such that the power of the first two of these peaks is equal.

### TECHNICAL FIELD OF THE INVENTION

The present invention relates to optical pulse-stretchers for reducing the peak power of laser pulses while conserving pulse energy. The application relates to such a pulse-stretcher in the form of an imaging delay line.

### DISCUSSION OF BACKGROUND ART

In many applications where pulse laser radiation is used, for example, in laser material processing, laser printing, microlithography, and medical and surgical treatment, it is the energy of a pulse that is of interest rather than the peak power within the pulse. Indeed, in several such applications, too high a peak power can cause damage to whatever is being exposed to the radiation pulses, or to optical devices used to deliver the pulses. This can become particularly problematical if a higher pulse-energy would be useful, while a maximum peak power must not be exceeded. Since the duration of the laser pulse in most lasers is fixed, a pulsed laser providing higher energy would automatically increase the pulse peak power.

By way of example, in UV (ultraviolet) microlithography for semiconductor device manufacture, photo-masks are formed by exposing photoresist to pulsed UV radiation from excimer lasers. The more energy per pulse that an excimer laser can deliver at any given pulse rate, the higher the manufacturing throughput will be. A high, peak pulse-intensity however can rapidly degrade optical elements of a projection system used to expose the photoresist for writing the photomask pattern therein.

In order to avoid such degradation, it has become common practice in the semiconductor industry to temporally stretch a pulse delivered by an excimer laser before it is delivered to the projection system. The temporal stretching is accomplished in a way that decreases the peak pulse-intensity while conserving, to the maximum extent possible, the energy of the original (un-stretched) pulse.

A commonly used pulse-stretching arrangement is an optical delay line in the form of a relay-imaging system. Such a system is illustrated schematically in FIG. 1. Here, stretcher 10 comprises a beamsplitter 12, and a delay loop 14, including a plane mirror 16 and concave mirrors 18, 20, and 22. In this drawing, the path of light through the delay loop is indicated by a single line.

Mirrors 22 and 18 preferably each have a focal length f₁ and mirror 20 has a focal length f₂, where f₁ is about equal to 2 times f₂. The concave mirrors relay an image of an incoming pulse P₀ at the beamsplitter back onto the beamsplitter replicating the image size, position, pointing and divergence of the original pulse. Those skilled in the optical art will recognize that there is an intermediate focus (not illustrated) between mirrors 18 and 20 and also between mirrors 20 and 22.

A portion of pulse P₀ incident on beamsplitter 12 is transmitted by the beamsplitter and does not enter loop 14. This transmitted portion, designated pulse P₁ in FIG. 1, is often referred to as the “prompt” pulse, as this pulse is transmitted without significant delay. Another portion of pulse is reflected by the beamsplitter and follows a path through delay loop 14 being sequentially reflected by mirrors 16, 18, 20, and 22 before returning to the beamsplitter.

Beamsplitter 12 reflects a portion (first replica) of this delayed portion of the pulse along the same path as the first-transmitted portion but delayed by a time τ, which is the round trip time in delay loop 14. This first replica pulse is designated P₂ in FIG. 1. Beamsplitter 12 transmits a portion of this replica pulse which undergoes further delays and division into reflected and transmitted portions. A subsequently-delayed portion has lesser energy than a previously-delayed portion. In theory at least, the number of round trips and replica pulses is infinite. In practice, however, and in particular in a lossy system, the energy of replica pulses becomes vanishingly small after as few as three replica pulses have been produced. This energy diminution depends on the reflectivity of the beamsplitter and loss per round trip in the delay loop. In FIG. 1 a total of four pulse portions are shown, being prompt pulse P₁, and increasingly delayed replicas P₂, P₃, and P₄. These pulse portions or replicas, collectively, form a stretched pulse.

The optimum reflectivity R of the beam splitter depends on the transmission T of the delay line and can be calculated, approximately, from a formula:

$$S = \frac{{( 1 - R + \frac{{R}^{2} T}{1 - ( 1 - R ) T} )}^{2}}{{( 1 - R )}^{2} + \frac{{R}^{4} {T}^{2}}{1 - {( 1 - R )}^{2} {T}^{2}}} \qquad ( 1 )$$

where S is the stretch factor. However, the formula is only reliable if the prompt pulse P1 and replicas P₂ through P_{N} are fully separated in time. For values of T between 90% and 80%, R falls in the range between about 60% and 67%. With this reflectivity, the prompt beam and the first replica have about the same intensity. All following replicas have decreasing intensity. In theory, the optimum reflectivity can be approximated by calculating the derivative (∂S/∂R), equating the derivate to equal zero, separating R and solving the resulting equation. This, however is an extremely daunting task, to say the least. Simpler is to plot equation (1) for any given value of T, and determine the value of R when S reaches a peak, i.e., when ∂S/∂R is zero.

FIG. 2 is a graph schematically depicting computed stretching factor (S) as a function of reflectivity (R) for a range of transmission values from 80% to 100% (with values indicated on the curves). Here, it should be noted that the transmission of the delay loop itself is weakly dependent on the reflectivity of the beamsplitter. FIG. 3 schematically illustrates computed power as a function of time for a hypothetical “sech-squared” input pulse P₀ and a stretched output-pulse in an example of the prior-art pulse-stretcher of FIG. 1 having 100% transmission and a beamsplitter reflectivity of about 61.7% The maximum possible stretching factor S is about 3 if transmission is 100%, i.e., if the delay loop is lossless. At excimer laser UV wavelengths, the delay loop, in practice, will almost always have less than 100% transmission. Optimum performance is only obtained if the pulse duration of pulse P₁ is about equal to the delay τ of delay loop 14. Any further delay does not further significantly reduce the peak intensity of the highest-intensity replica pulse, but merely further separates the replica pulses and creates a discontinuity in the flow of energy to whatever is being irradiated by the pulse replicas. It would be usefully to be able to further reduce peak intensity of a delivered pulse without a significant increase in the number of optical elements beyond that of the above-described pulse-stretcher.

### SUMMARY OF THE INVENTION

The present invention is directed to apparatus for extending the duration and reducing peak power in an optical pulse. In one aspect apparatus in accordance with the present invention comprises an optical delay loop including a beamsplitter. The optical delay loop is in the form of an imaging optical system. The beamsplitter is arranged cooperative with the delay loop to divide the optical pulse into a first temporal sequence of pulse replicas each thereof having about the same beam dimensions, a first of which is transmitted by the beamsplitter and the remainder of which are reflected by the beamsplitter along the path of the transmitted replica. The sequence of pulse replicas propagates along a first common path. An optical arrangement is provided for directing the first sequence of pulse replicas back into the delay loop along a path laterally displaced from the first common path. The beamsplitter divides the firs sequence of pulse replicas into a second temporal sequence of pulse replicas each thereof having about the same beam dimensions and each thereof propagating along a second common path laterally displaced from the first common path to form a finally-stretched pulse. The finally-stretched pulse has a longer duration and a lower peak power than the optical pulse.

The finally stretched pulse is characterized by a sequence of power peaks spaced apart in time by about the round trip period of the delay loop. Maximum peak power of the finally stretched pulse is minimized when the beamsplitter reflectivity is selected such that the power in the first and second peaks is equalized. In this condition, the power in the first and second peaks is the maximum power in the finally stretched pulse with the third and subsequent peaks having progressively less power.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates a prior art relay-imaging pulse-stretcher having a beamsplitter and a delay loop including one plane and three concave mirrors.

FIG. 2 is a graph schematically illustrating computed stretching factor as a function of beamsplitter reflectivity for various values of transmission in the pulse-stretcher of FIG. 1.

FIG. 3 is a graph schematically illustrating computed power as a function of time for an input pulse and a stretched pulse in one example of the prior-art pulse-stretcher of FIG. 1.

FIG. 4 schematically illustrates a preferred embodiment of a relay-imaging double-pass pulse-stretcher in accordance with the present invention, including a beamsplitter cooperative with a relay-imaging delay loop and a prism arranged such that a stretched pulse exiting the delay loop after a first pass therethrough is axially displaced and redirected back into the delay loop to be further stretched by a second pass therethrough.

FIG. 5 is a graph schematically illustrating computed power as a function of time for a hypothetical sech-squared input pulse P₀, and once-stretched and twice-stretched pulses from respectively first and second passes through one example of the pulse-stretcher of FIG. 4.

FIG. 6 is a graph schematically illustrating computed optimum reflectivity as a function of delay loop transmission for the beamsplitter in the double-pass pulse-stretcher of FIG. 4.

FIG. 7 is a graph schematically illustrating computed power as a function of time for a hypothetical sech-squared input pulse twice-stretched in an example of the inventive pulse-stretcher wherein the beamsplitter has a reflectivity of 61.7%, and for the same pulse twice-stretched in an example of the inventive pulse-stretcher wherein beamsplitter 12 has a reflectivity of about 49.8%.

FIG. 8 is a graph schematically illustrating computed power as a function of time for a hypothetical sech-squared input pulse once stretched in a prior-art pulse stretcher, and twice-stretched in an example of the inventive pulse-stretcher wherein the beamsplitter reflectivity is specifically optimized to minimize peak power, independent of stretching.

FIG. 9 is a graph schematically illustrating computed power as a function of time for a hypothetical sech-squared input pulse for the input pulse after being twice-stretched in an example of the inventive pulse-stretcher wherein the beamsplitter reflectivity is specifically optimized to minimize peak power, independent of stretching.

FIG. 10 schematically illustrates another preferred embodiment of a relay imaging double-pass pulse-stretcher in accordance with the present invention similar to the pulse-stretcher of FIG. 4 but including two beamsplitters, one of which may have a different reflectivity from that of the other

### DETAILED DESCRIPTION OF THE INVENTION

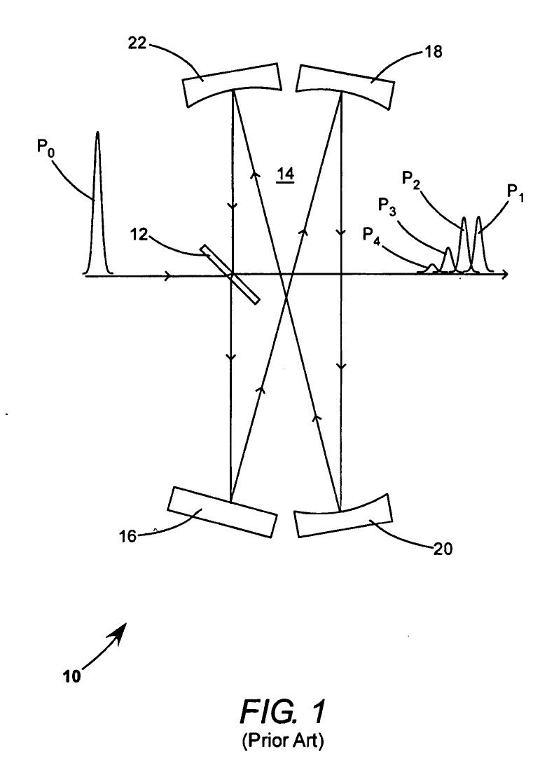

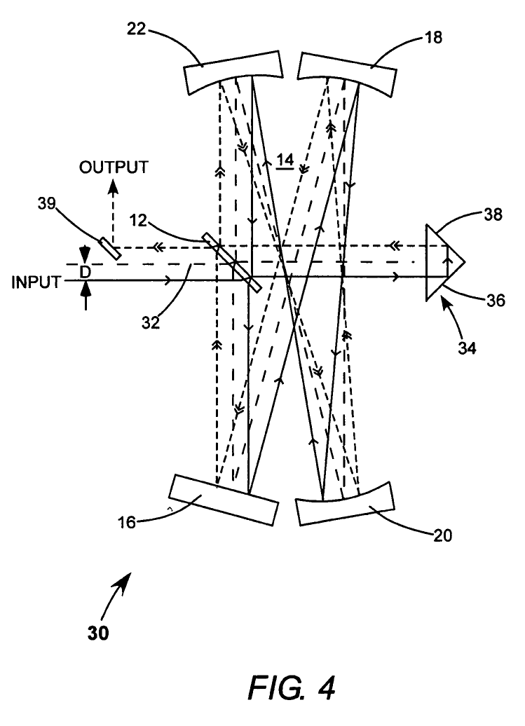

Referring now to the drawings, wherein like components are designated by like reference numerals, FIG. 4 schematically illustrates one preferred embodiment 30 of a double pass relay-imaging pulse-stretcher in accordance with the present invention. Pulse-stretcher 30, in this embodiment, includes a delay loop 14 with mirrors 16, 18, 20, and 22 arranged as described above in the pulse-stretcher of FIG. 1 to form a relay imaging optical system of about unit (about 1:1) magnification. The optical axis of the delay loop is depicted in FIG. 4 by a long dashed line 32.

Pulse-stretcher 30 makes use of the fact that the relay-imaging delay loop is insensitive to the position and pointing of an incident beam. After one round trip in the delay loop, the size, position, pointing, and divergence of the input beam are replicated, provided that the delay loop itself remains properly aligned. Tilting the delay loop or moving the delay loop (pulse-stretcher assembly), within certain limits, will not affect the performance of the delay loop. The limits depend, inter alia, on the optical aperture of the optical elements of the delay loop. As noted above, mirrors 22 and 18 preferably each have a focal length f₁, and mirror 20 preferably has a focal length f₂, where f₁ is about equal to 2 times f₂. This being the case, mirrors 20 and 22 and mirrors 18 and 20 are preferably separated by a distance f₁+2f₂, and mirrors 18 and 22 are axially separated by a distance 2f₁+f₁²/f₂.

In the inventive pulse-stretcher, an input beam (pulse), depicted in FIG. 1 by a solid line, with the propagation direction of the beam indicated by single arrowheads, is directed into the delay loop, through beamsplitter 12, displaced by a distance D from optical axis 32. After a first pass through the beamsplitter, the input pulse replicas (not shown) exit the delay loop in the same direction, with the same displacement from the axis, on the same side of the axis, and with the same dimensions (beam cross-section).

The replica pulses enter a prism 34 and emerge from the prism, after successive reflections from faces 36 and 38 thereof, displaced on the opposite side of the axis from the input put beam and propagating in the opposite direction to the original input beam. Prism 34 of course may be replaced with separate mirrors fulfilling the function of internal reflective surfaces 36 and 38 of the prism. The displaced and direction-reversed beam is depicted as a short-dashed line to assist in tracing the path of the beam through the delay loop. The propagation direction is indicated by double arrowheads.

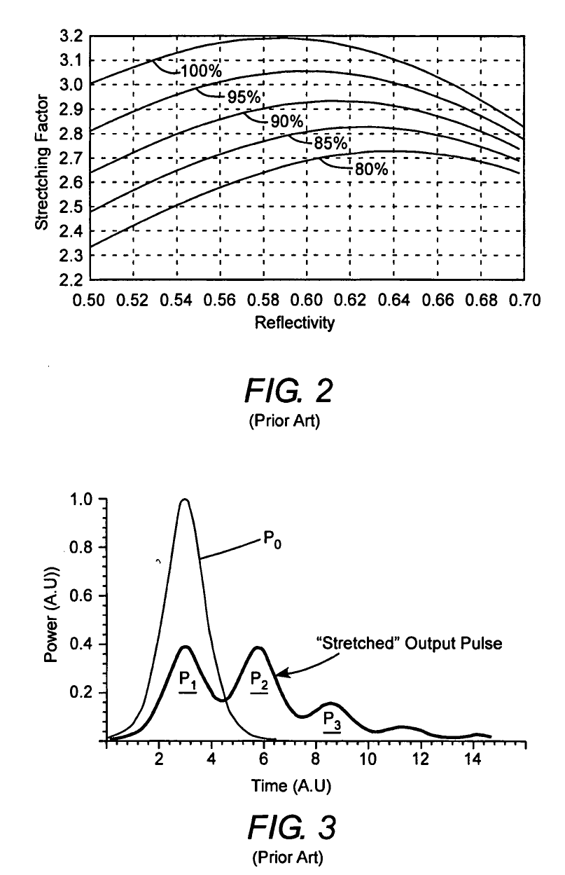

It can be considered (initially at least) that a stretched pulse of a temporal form similar to that depicted in FIG. 2 for a prior-art pulse provides a new input pulse for a second pass through delay loop 14. In that second pass, the once-stretched pulse is divided into a temporal sequence of replicas by the beamsplitter and the delay loop to provide a twice-stretched pulse (Output) having a longer duration and lower peak intensity than the once-stretched pulse. The twice-stretched pulse is intercepted by a mirror 39 and directed away from the optical axis.

If pulse P₀ has a duration of about 24 nanoseconds (ns), which is a typical duration for excimer laser pulses, delay loop 14 will preferably have a round trip optical path of about 7.2 meters. Focal lengths f₁ and will be about 900 millimeters (mm) and 450 mm respectively. The apertures of the mirrors depend on the size of the beam and the allowed movement and tilt range of the assembly. Preferably, the apertures should be between about 3 and 4 times the beam size. By way of example for an input beam size of 3 mm×12 mm, 50 mm optics are preferred. In such an arrangement, a displacement D from the optical axis of up to about 5 mm to 10 mm is possible, while still having the delay loop function, optically, as desired. Entrance and exit beams need neither be symmetrically disposed about axis 32, nor parallel to the axis as depicted in FIG. 4. The depicted arrangement, however, will provide the maximum possible lateral separation of the input and output beams consistent with proper operation of the delay loop.

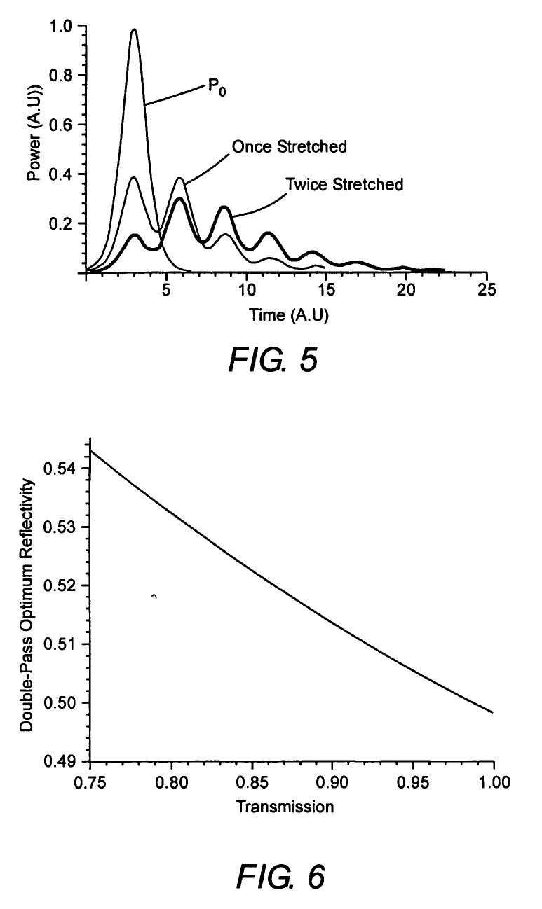

FIG. 5 is a graph schematically illustrating computed power as a function of time for a hypothetical sech-squared input pulse P₀, and the once-stretched and twice-stretched pulses from respectively first and second passes through pulse-stretcher 30 of FIG. 4. Here again, it is assumed that the stretcher has 100% transmission. Beamsplitter 12 is assumed to have a reflectivity of about 61.7%, which is about the optimum reflectivity according to prior-art assumptions. It is also assumed that the round trip delay in the delay loop is about equal to the pulse duration of the input pulse P₀. Time is shown in arbitrary units to facilitate comparisons. The present invention is not limited to stretching pulses of any particular duration. One skilled in the art will be able to factor the graphs to determining the duration of stretched pulses generated from any assumed input-pulse duration.

It can be seen that the twice-stretched pulse is stretched by comparison with the once-stretched pulse, but by a lesser factor than the once-stretched pulse is stretched by comparison with the input pulse P₀. In the example of FIG. 5, the stretching factor on the first pass is almost 3.0 while the stretching factor on the second pass is between about 1.4 and 1.5. It can also be seen, however, that the peak power in the twice-stretched pulse is only reduced by about 20% compared with that of the once-stretched pulse. The reason for this is that, as the power-peaks in the once-stretched pulse are spaced apart in time essentially by the round trip delay time of delay loop 14, the first peak of the first replica of the once-stretched pulse reinforces the second peak of the prompt portion of that pulse that is transmitted by beamsplitter 12. This will occur whatever the delay time of delay loop 14.

In an attempt to make the inventive double-pass pulse-stretcher more effective in reducing peak power in a twice-stretched pulse, an investigation was carried out to determine if this could be accomplished by finding a reflectivity for beamsplitter 12 that is different from that indicated by prior-art teachings for a prior-art, single-pass pulse-stretcher. It was determined that if a reflectivity was selected that would make the first and second power peaks of a twice-stretched pulse about equal, that condition would provide the lowest peak power achievable in the twice-stretched pulse for any selected delay-time of the delay loop.

FIG. 6 is a graph schematically illustrating computed optimum reflectivity as a function of transmission (solid curve) for beamsplitter 12 in the inventive double-pass pulse-stretcher of FIG. 4 for a practical range of transmission values from about 75% to 100%. It can be seen that the (double-pass) optimum reflectivity for the inventive double-pass stretcher lies between about 55% and 48%. For a prior-art single-pass stretcher, the optimum reflectivity lies between about 67% and 60% for the same transmission range (see FIG. 2).

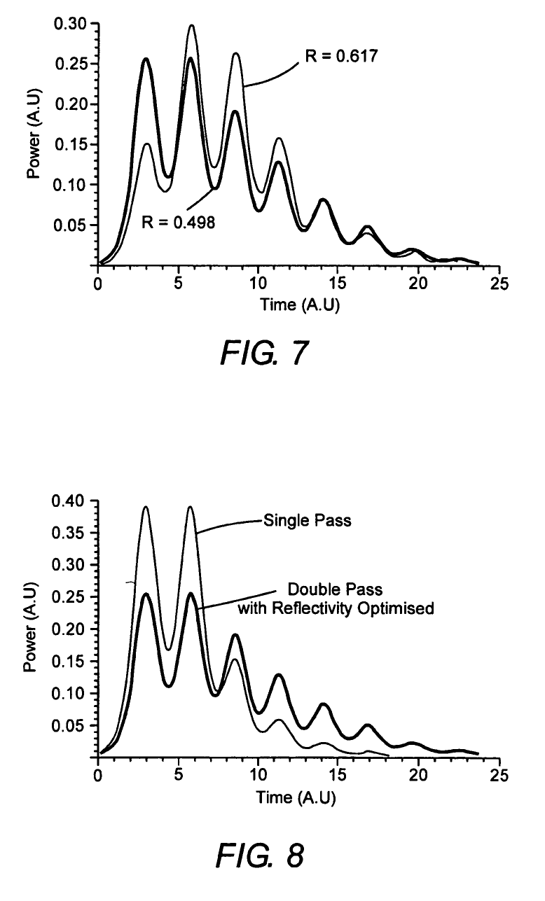

FIG. 7 is a graph schematically illustrating computed power as a function of time for a hypothetical, sech-squared input-pulse, twice stretched in an example of the inventive pulse-stretcher wherein beamsplitter 12 is assumed to have a reflectivity of about 61.7% (single weight curve), and twice stretched in an example of the inventive pulse-stretcher wherein beamsplitter 12 is assumed to have a reflectivity of about 49.8% (double weight curve). It is assumed, in each example, that the stretcher has 100% transmission, and that the round trip delay in delay loop 14 is about equal to the pulse duration of the input-pulse P₀. The twice-stretched pulse is characterized by a sequence of power peaks spaced apart in time by about the round trip period of the delay loop.

It can be seen from FIG. 7 that the lower reflectivity of beamsplitter 12 provides a reduction of about 15% in the peak intensity of the twice-stretched pulse compared with the example wherein the beamsplitter has the prior-art-indicated reflectivity of 61.7 percent, and that, in general, there is a better distribution of energy between the first three peaks of the twice stretched pulse. In this “optimized” condition, the power in the first and second peaks is the maximum power in the twice-stretched pulse with the third and subsequent peaks having progressively less power. The actual temporal stretching is about the same in each example. It should be noted that as the transmission of the delay loop decreases, the reduction in power due to the new optimum reflectivity will be less, but still significant, for example, between about 10% and 12% for a transmission of about 80.

FIG. 8 is a graph schematically illustrating computed power as a function of time for a hypothetical sech-squared input pulse once stretched in an example of the prior-art pulse stretcher of FIG. 1 (wherein the beamsplitter reflectivity is about 61.7%), and twice-stretched in an example of the inventive pulse-stretcher wherein the beamsplitter reflectivity is specifically optimized (here, at 49.8%) to minimize peak power after a double pass, regardless of stretching factor. Transmission is assumed to be 100%. The peak power after twice stretching a pulse in the inventive double-pass stretcher is reduced to about 64% of what the power would be after passing through a prior-art pulse-stretcher. A reduction to only about 77% of the single-pass value is obtained if prior-art guidelines are followed for determining beamsplitter reflectivity.

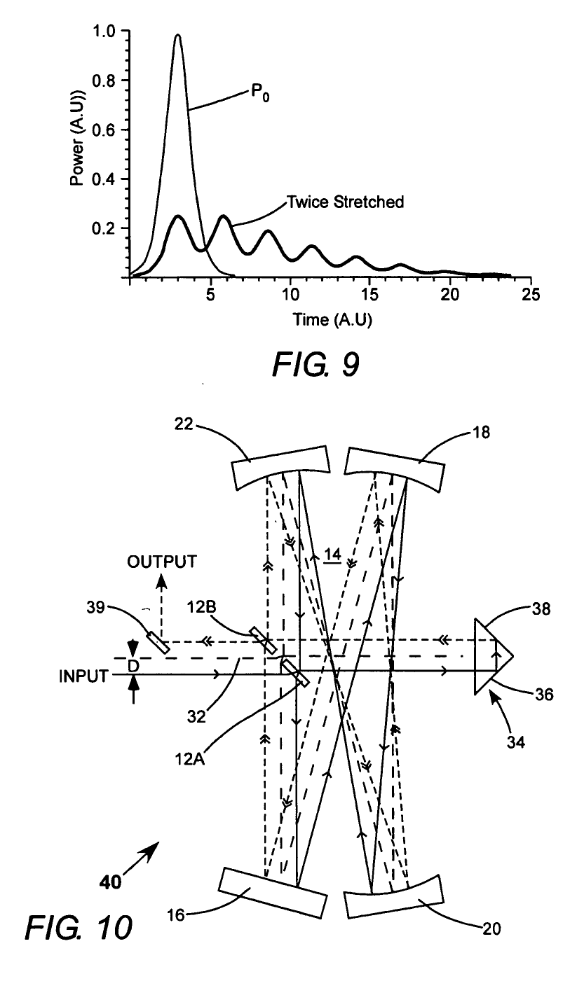

FIG. 9 is a graph schematically illustrating computed power as a function of time for a hypothetical sech-squared input pulse P₀ (fine curve) for the input pulse after being twice-stretched in an example of the inventive pulse-stretcher (bold curve) wherein the beamsplitter reflectivity is specifically optimized to minimize peak power, independent of stretching. Transmission of the delay loop, here, is assumed to be 100%. It can be seen that the peak power in the twice-stretched (output) pulse is about 26% of the peak power of input pulse P₀. For a loop having less than 100% transmission the peak power in the output pulse would be less than 26% of the input pulse by an amount dependent on the transmission of the loop.

FIG. 10 schematically illustrates another preferred embodiment 40 of a double-pass, relay-imaging pulse-stretcher in accordance with the present invention. Pulse-stretcher 40 is similar to pulse-stretcher 30 of FIG. 4, with an exception that beamsplitter 12 of pulse-stretcher 30 is replaced in pulse-stretcher 40 by two different beamsplitters 12A and 12B on opposite sides of the optical axis of delay loop 14. These two beamsplitters, while depicted as being on separate substrates in FIG. 8, may simply be zones of different reflectivity on a common substrate. Beamsplitter 12A controls energy distribution in the once-stretched pulse, and beamsplitter 12B controls energy distribution in the twice stretched pulse.

Providing two separate beamsplitters means that one of the beamsplitters can have a different reflectivity from the other. For any given round trip loss value of the delay loop it is possible to find two different reflectivity values that will provide equal power in the first two peaks of a twice-stretched pulse. However, the power in the first two peaks is only minimized when the reflectivity of each beamsplitter is equal to the optimum value for a single beamsplitter.

Those skilled in the optical art will recognize that the relay-imaging arrangement of delay loop 14 in above described embodiments of the present invention is not the only optical arrangement that will provide 1:1 imaging with preservation of beam pointing and position, and that any other such arrangement may be used without departing from the spirit and scope of the present invention. Those skilled in the art will also recognize, however, that such an arrangement will include at least two optical elements having positive optical power, an optical element, here, referring to a mirror or a lens. By way of example, a delay line may be used that replicates the beam with an inverted image. An inverted image does not present a significant problem for a beam that is symmetrical in vertical and horizontal axes. Such a delay line would require only two curved mirrors (or two lenses) with the focal lengths of the mirrors being equal. It is difficult, however, to use such an imaging arrangement in a four mirror loop, since there will be a flat mirror between the two curved mirrors, on which there is a focus. This can be avoided by using a loop with more than 4 mirrors. This becomes of interest if the delay line loop has to be several meters long or folded more than four times to reduce the physical space of the delay loop. At ultraviolet wavelengths, where some optical loss in components of the delay loop is essentially inevitable, more than four mirrors in a delay loop could significantly reduce transmission of the delay loop.

In summary, the present invention is described above in terms of a preferred and other embodiments. The invention is not limited, however, to the embodiments described and depicted. Rather, the invention is limited only by the claims appended hereto.

What is claimed is:

1. Apparatus for extending the duration of an optical pulse comprising:
an optical delay loop, said optical delay loop being in the form of an imaging optical system and having an optical axis;
a beam dividing arrangement located within said optical delay loop, said beam dividing arrangement arranged cooperative with said delay loop to divide the optical pulse into a first temporal sequence of pulse replicas each thereof having about the same beam dimensions, a first of which is transmitted by the beamsplitter and the remainder of which are reflected by the beamsplitter along the path of the transmitted replica, said first sequence of replicas propagating along a first common path; and
an optical arrangement for directing said first sequence of pulse replicas back into the delay loop along a path laterally displaced from said first common path, said beam dividing arrangement dividing said first sequence of pulse replicas into a second temporal sequence of pulse replicas each thereof having about the same beam dimensions and each thereof propagating along a second common path laterally displaced from said first common path, said first and second sequences of pulse replicas forming a finally-stretched pulse having a longer duration and a lower peak power than the optical pulse.

2. The apparatus of claim 1, wherein, said imaging optical system of said delay loop is a unit magnification relay-imaging optical system.

3. The apparatus of claim 1, wherein said finally-stretched pulse has a sequence of power peaks spaced apart in time and said beam dividing arrangement is arranged such that the power of the first two of said power peaks is about equal.

4. The apparatus of claim 3, wherein said beam dividing arrangement is a beamsplitter.

5. The apparatus of claim 4, wherein said beamsplitter has a reflectivity between about 55% and 48%.

6. The apparatus of claim 3, wherein said beam dividing arrangement includes first and second beamsplitters, said first beamsplitter cooperative with said delay loop to divide the optical pulse into said first temporal sequence of pulse replicas, and said first beamsplitter cooperative with said delay loop to divide the optical pulse into said second temporal sequence of pulse replicas.

7. The apparatus of claim 6, wherein said first and second beam splitters have respectively first and second reflectivities.

8. The apparatus of claim 7, wherein said first and second reflectivities are about the same

9. The apparatus of claim 1, wherein said delay loop includes 3 concave mirrors and one plane mirror.

10. The apparatus of claim 9, wherein two of said concave mirrors have a focal length f₁, and one of said concave mirrors has a focal length f₂, and wherein f₁ is about equal to 2 times f₂.

11. The apparatus of claim 1, wherein said optical arrangement for directing said first sequence of pulses pulse back into the delay loop includes first and second reflective surfaces.

12. The apparatus of claim 11, wherein said first and second reflective surfaces are internally reflective surfaces of a prism.

13. The apparatus of claim 1, wherein said first and second common paths are laterally spaced apart on opposite sides of the optical axis of said delay loop.

14. The apparatus of claim 13, wherein said first and second common paths are parallel to the optical axis of said delay loop.

15. Apparatus for extending the duration of an optical pulse comprising:
an optical delay loop, said optical delay loop being in the form of a unit magnification, relay-imaging optical system and having an optical axis and a delay time;
a beam dividing arrangement located within said optical delay loop, said beam dividing arrangement arranged cooperative with said delay loop to divide an optical pulse incident on the beam dividing arrangement along an input path into a first temporal sequence of replicas of the optical pulse, each thereof having about the same beam dimensions, a first of which is transmitted by the beamsplitter out of said delay loop and the remainder of which are reflected by the beamsplitter out of said delay loop along a first common path with the transmitted replica;
an optical arrangement for directing said first temporal sequence of pulses back into the delay loop along a second common path laterally displaced from said first common path, said beam dividing arrangement dividing said first temporal sequence of pulses into a second temporal sequence of pulse replicas, each thereof having about the same beam dimensions, a first of which is transmitted by the beamsplitter out of said delay loop and the remainder of which are reflected by the beamsplitter out of said delay loop and each thereof propagating along a common output path, laterally displaced from said input path to form a finally-stretched pulse having a longer duration and a lower peak power than the optical pulse, said finally stretched pulse characterized as having a sequence of power peaks spaced apart in time by about said delay time; and
wherein said beam dividing arrangement is arranged such that a first and second occurring of said power peaks have about equal power.

16. The apparatus of claim 15, wherein said beam dividing apparatus is a beamsplitter having a reflectivity selected such that first and second occurring of said power peaks have about equal power.

17. The apparatus of claim 15, further including a mirror arranged in said output path for directing said finally stretched pulse away from said input path of the optical pulse.

18. Apparatus for extending the duration of an optical pulse comprising:
an optical delay loop, said optical delay loop including a plurality of mirrors at least some of which are focusing mirrors to provide an imaging optical system and having an optical axis;
a beam divider for transmitting a first portion of the optical pulse and reflecting the remaining portion of the pulse into the delay loop, said delay loop being configured to return the reflected pulse back the beam divider wherein a portion of the once delayed pulse will be reflected out of the delay loop along a path common with the first portion of the pulse and a portion of the once delayed pulse will be transmitted back into the delay loop; and
a reflector element positioned to receive the first portion of the optical pulse transmitted by the beam divider and the delayed pulse portions reflected from the beam divider and for redirecting received pulses along a laterally displaced path back to said beam divider and wherein said beam divider transmits a portion of the pulses received along that displaced path to define the output of the apparatus and reflecting a second portion of those pulses back into the delay loop, said delay loop being configured to return the reflected second portions of the pulses back to the beam divider wherein a portion thereof is reflected to contribute to the output of the apparatus and a portion is transmitted, with the output of the apparatus defining a finally-stretched output pulse having a longer duration and a lower peak power than the optical pulse.

19. The apparatus of claim 18, wherein said reflector element is a prism.
